(19) United States
(12) Patent Application Publication
(10) Pub. No.: US 2018/0075412 A1
(43) Pub. Date: Mar. 15, 2018

(54) COLLABORATION NOTIFICATION OF DEVELOPMENT BASED ON ARTIFACT ANALYSIS

(71) Applicant: CA, Inc., New York, NY (US)

(72) Inventor: Srikanth Mandava, Hauppauge, NY (US)

(21) Appl. No.: 15/262,516

(22) Filed: Sep. 12, 2016

(51) Int. Cl. G06Q 10/10; G06F 9/44

(52) U.S. Cl. CPC G06Q 10/101; G06F 8/36

(57) ABSTRACT

Based on creation or assignment of a first artifact for a collaborative product development in an enterprise, identifying first text in the first artifact is identified. For each of a plurality of stored artifacts of the enterprise, a determination is made of whether the stored artifact includes a second text that matches the first text identified in the first artifact to a degree that satisfies a matching threshold. In response to determining satisfaction of the matching threshold, a determination is made of whether the first artifact satisfies a collaboration criterion that is based, at least in part, on an attribute of at least one of the first artifact and the stored artifact. In response to determining that the collaboration criterion is satisfied, a collaboration notification regarding the stored artifact is transmitted.

### BACKGROUND

The disclosure generally relates to the field of data processing, and more particularly to collaboration notification of development based on artifact analysis.

Enterprises (e.g., business entities) that develop products (e.g., hardware, software, etc.) can grow in terms of groups, teams, persons, etc. In such enterprises, team and organizational boundaries can limit the amount of communication and awareness regarding development by other groups, teams, persons, etc. therein.

### BRIEF DESCRIPTION OF THE DRAWINGS

Embodiments of the disclosure may be better understood by referencing the accompanying drawings.

FIG. 1 depicts a system architecture for collaboration notification of development based on artifact analysis, according to some embodiments.

FIG. 2 depicts an example framework for a development methodology, according to some embodiments.

FIG. 3 depict a flowchart for collaboration notification of development based on artifact analysis, according to some embodiments.

FIG. 4 depicts an example computer device, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to collaboration for development of software in an enterprise. But aspects of this disclosure can be applied to various other product developments within an enterprise. In other instances, well-known instruction instances, protocols, structures and techniques have not been shown in detail in order not to obfuscate the description.

### Terminology

This description uses the term “enterprise” to refer to any organization, business entity, venture, partnership, corporation, establishment, etc. that develops and delivers products, such as software, hardware, any type of widget, etc. The enterprise can include a number of team members or persons. The team members can be grouped together into teams. Also, multiple teams can be grouped together based on various logical boundaries within the enterprise. For example, the teams can be grouped into different departments, divisions, and/or areas within the enterprise. For example, department A includes 10 teams that develop product X, while department B includes 17 teams that develop product Y.

This description uses the term “artifact” to refer to any type of description, definition, or requirement used to develop products within an enterprise. An example of an artifact is a story within an Agile software development methodology for product development. A story defines a system behavior that includes a description of desired functionality or intended behavior. The story can be written from a perspective of a user of the product. Also, the story can be defined to allow for highly incremental development. Another example of an artifact is an epic that is a container for significant initiatives for the enterprise within the Agile software development methodology. An epic can be comprised of a number of stories. A feature in the Agile software development methodology is another example artifact. A feature defines a service or distinct element that contributes to the overall functionality of the product, system, etc. being developed. A story can be an aspect of a feature. However, a story can encompass multiple features. Another example artifact is a capability in the Agile software development methodology. A capability can be similar to features but define a higher-level behavior of the product being developed.

### Overview

Embodiments can improve productivity and foster collaboration in the development of products (e.g., software) by providing suggestions, notifications, etc. of similar work items or development being performed by other members, teams, etc. in an enterprise, a business entity, etc. Notifications or suggestions of collaboration can be based on analysis of text in various artifacts that are created or updated as part of product development. In some embodiments, the infrastructure, team creation, member roles, etc. for software development is based on an Agile software development methodology. Using one of the Agile software development methodologies, software requirements and solutions evolve through a collaborative effort among teams and team members. An example Agile methodology for development of software is described below.

An artifact can be assigned to a team member, team, group, etc. A new artifact can be defined as an artifact that has been newly created or assigned. In some embodiments, a member(s) assigned to the new artifact can be notified of similar, current artifacts, another person(s) assigned to the similar current artifacts, etc. For example, a member(s) assigned to the new artifact can be notified of current artifacts assigned to other members in the enterprise who are producing a same or similar work, solving a same or similar problem, etc. Key terms in the new artifact can be identified. For example, a search engine can process the new artifact to identify key search terms therein. The current artifacts can then be searched using various text-based searching engines to locate those current artifacts having same or similar terms to the key terms in the new artifact. Those current artifacts having same or similar terms can be defined as current artifacts eligible for collaboration notification.

In some embodiments, the member(s) assigned to the new artifact is notified of those eligible, current artifacts that satisfy a collaboration criterion. If an eligible, current artifact satisfies the collaboration criterion, a notification can be transmitted to the member(s) assigned to the new artifact regarding potential collaboration with a team member(s), or a team(s) assigned to the current artifact. The collaboration criterion can be based on various attributes of the new and current artifacts. For example, the collaboration criterion can be based on the member, team, etc., of the new or current artifacts. For instance, a current artifact can be limited to collaboration use to a defined group (e.g., team, product group, etc.), specific individuals, etc., within the enterprise. In another example, a current artifact can be restricted to preclude any collaboration.

Other collaboration criteria can be based on the infrastructure of the enterprise and the development methodology (e.g., an Agile development methodology). For example, a collaboration criterion can be based on the number of vertical levels between the new and current artifact within the enterprise. In particular, members, teams, groups, etc. within an enterprise are assigned to different levels in the enterprise. For instance, a system architect may be at level 12 in the enterprise, while a low-level system test engineer may be at level 1. In these embodiments, a collaboration notification is only provided if the new artifact is assigned to a member, team, group, etc. that is within N vertical levels of a member, team, group, etc. assigned to the current artifact. Other collaboration criteria can be specific to the Agile software development methodology. For example, collaboration notification is only provided if the current artifact is beyond a certain program increment for the Agile Release Train. Other collaboration criteria are further described below.

### Example System Architecture

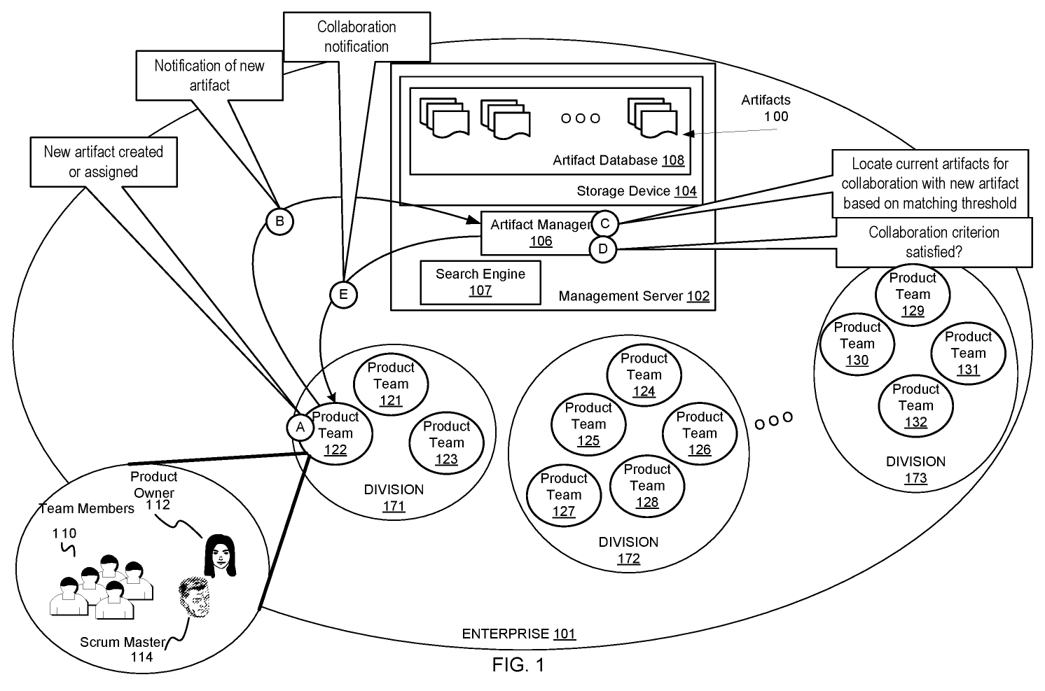

FIG. 1 depicts a system architecture for collaboration notification of development based on artifact analysis, according to some embodiments. FIG. 1 depicts an enterprise 101 that can represent any organization, business entity, venture, partnership, corporation, establishment, etc. that develops and deliveries products, such as software, hardware, any type of widget, etc.

The enterprise 101 includes a management server 102. The management server 102 includes an artifact manager 106, a search engine 107, and a storage device 104. The artifact manager 106 can be software, hardware, firmware, or a combination thereof to determine collaboration among artifacts and provide collaboration notification for artifacts satisfying a collaboration criterion. The search engine 107 can also be software, hardware, firmware, or a combination thereof to locate key search terms in new artifacts and to locate current artifacts having similar or same terms as the key search terms in the new artifacts.

The storage device 104 can be different types of machine-readable media for storage of data. For example, the storage device 104 can be a hard disk, a random access memory (RAM), Flash memory, an optical storage device, a magnetic storage device, or any combination of the foregoing. The storage device 104 stores an artifact database 108 that includes artifacts 100 created for the enterprise 101. For example, the artifacts 100 can include any type of description, definition, requirement used to develop products within an enterprise. For instance, the artifacts 100 can be epics, capabilities, features, stories, etc. in an Agile development methodology.

The enterprise 101 can include various numbers of divisions, wherein each division can include one or more product teams. In this example, the enterprise 101 includes divisions 171-173. The divisions 171-173 can represent logical partitions in the enterprise 101 for grouping of persons referred to as team members into various product teams. For example, the division 171 can be for development of product A. The division 172 can be for development of product B. And, the division 173 can be for development of product C. The division 171 includes product teams 121-123. The division 172 includes product teams 124-128. The division 173 includes product teams 129-132. The individual members of the product teams 129-132 can have devices, computers, etc. that are communicatively coupled to the management server 102. Communications can be established between the management server 102 and these different devices, computer, etc. for the individual members to allow for exchange of data about new and current artifacts, collaboration notification, etc.

FIG. 1 also depicts an example team that is based on the Agile development methodology. The example team includes a product owner 112, a scrum master 114, and team members 110. The product owner 112 can be the person on the team responsible for defining stories and prioritizing the team backlog. The product owner 112 can perform these responsibilities in the context of conceptual and technical integrity of the features or components for which the team is responsible. The product owner 112 can be the person to determine whether a story assigned to the team or team member is complete.

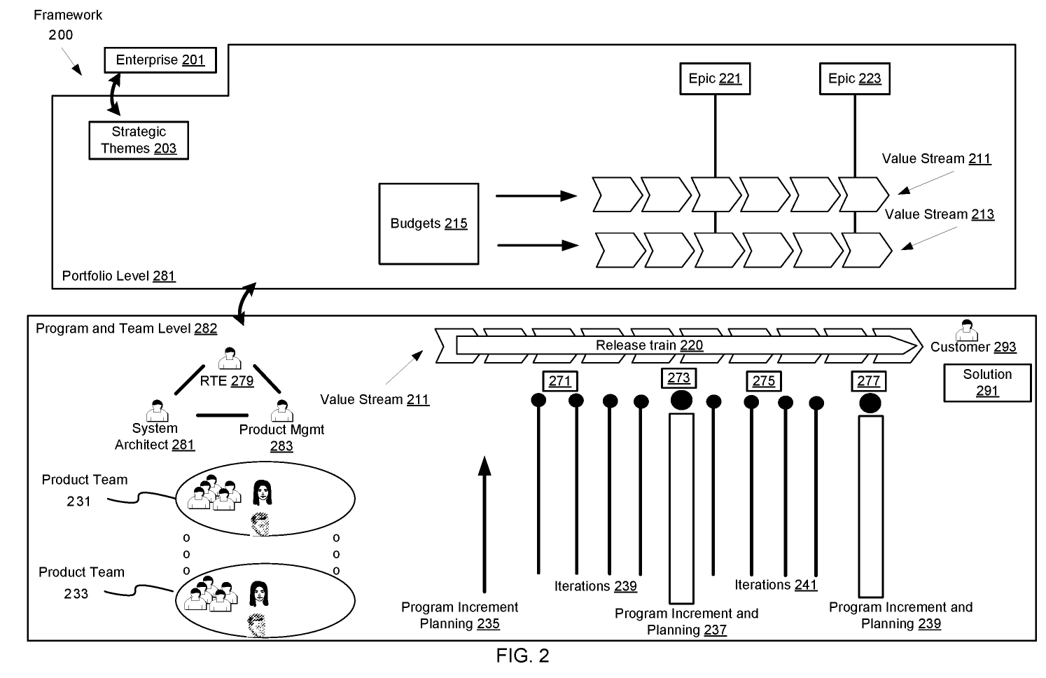

The scrum master 114 is a member of the team responsible for help the team members 110 achieve their goals (e.g., completion of stories). The team members 110 can be persons to define, develop, and test a component, functionality, feature, etc. of a product. For example, the team members 110 can define, develop, and test software, hardware, firmware, or a combination thereof. The individual members or a set of individual members of the team can be assigned a story. The team members 110 are further described below in reference to FIG. 2.

FIG. 1 is annotated with a series of letters A-E. These letters represent operational stages. Although these stages are ordered for this example, the stages illustrate one example to aid in understanding this disclosure and should not be used to limit the claims. Subject matter falling within the scope of the claims can vary with respect to the order and some of the operations.

At stage A, a new artifact is created or assigned to a person, group of persons, etc. For example, a story can be assigned to a team member of the product team 122. For instance, the story can include a description of a certain functionality that is to developed as part of a software product being developed by the product team 122. As an example, the product owner 122 can assign the story to the team member.

At stage B, in response to creating of assigning the new artifact, the device of the team member or the device of the product owner for the team can transmit a communication to the artifact manager 106 that the artifact has been assigned. The communication can include the artifact itself, who assigned the artifact, to whom the artifact has been assigned, identification of the product team 122, identification of the product to which the story is related, etc. The artifact manager 106 can store this data about the newly assigned artifact in the artifact database 108. Alternatively, the artifact manager 106 can create and assign the artifact based on instructions from the product owner or the team member. Additionally, key search terms can be identified in the new artifact. For example, the search engine 107 can process the new artifact to identify the key search terms. Alternatively or in addition, one or more persons can identify the key search terms in the new artifact. For example, the team member who has been assigned the artifact, the product owner for the team, etc. can identify the key search terms.

At stage C, current artifacts are located for collaboration for the new artifact based on a matching threshold. For example, the search engine 107 can process the current artifacts 100 being stored in the artifact database 108 to locate the current artifacts having same or similar terms as those identified as key search terms in the new abstract. For example, the search engine 107 can identify a current artifact has having same or similar terms if a matching threshold is met. For instance, if the current artifact has at least N number of same or similar terms, the search engine 107 can identify the current artifact as being a candidate for collaboration with the new artifact. The value of N can vary based on different criteria. For example, if the new artifact is a story for product X, the value of N can be lower in comparison to a new artifact for a story for product Z. In another example, if the current artifact is for a same product or a different product in a same division of the enterprise 101 as the new artifact, the value of N can be lower in comparison to a current artifact that is for a different product in a different division of the enterprise 101.

In another example, if the current artifact is from a person that is more than X number of levels above or below the person assigned to the new artifact, the value of N can be greater in comparison to a current artifact that is from a person that is less than X number of levels above or below the person assigned to the new artifact. Accordingly, in this example, the value of N is directly proportionate to the value of X. For instance, if the new artifact is from a low level programmer (level 1 in the enterprise 101), in order to find collaboration with a current artifact from a senior executive (level 20 in the enterprise 101), the number of same or similar terms would have to be great. This is in comparison to a situation where the new artifact is from a low level programmer (level 1 in the enterprise 101) and the current artifact is also from a low level programmer (level 1 in the enterprise 101). In this situation, the number of same or similar terms would be less.

At stage D, after selecting current artifacts that are eligible for collaboration for the new artifact, a determination is made of whether the eligible current artifacts satisfy a collaboration criterion. The artifact manager 106 can make this determination for each of the eligible current artifacts. The collaboration criterion can be based on an attribute of at least one of the new artifact or the current artifact. Collaboration criteria can also be based on the infrastructure of the enterprise and the development methodology (e.g., Agile development methodology). For example, the collaboration criterion can be that the new artifact be within N vertical levels of the current artifact within the enterprise. For instance, each artifact can be within a level of the enterprise based on the member(s) to which the artifact is assigned. To illustrate, assume a new artifact is a level 1 for a story defining functional requirements of a product assigned to a low level programmer (being a level 1), while a current artifact is a level 12 for an epic assigned to a system architect (being a level 12). For this example, these two artifacts would satisfy a collaboration criterion that requires the artifacts be within 11 or greater vertical levels.

In another example, the collaboration criterion can be that the current artifact be within a logical boundary of the enterprise 101. For instance, the criterion can be that the current artifact has been developed within a division X, department N, group K, etc. In some embodiments, the criterion can be that the new and current artifacts be in a same logical boundary of the enterprise 101. In other embodiments, the criterion can be that the new and current artifacts be in different logical boundaries. In another example, the collaboration criterion can be that the current artifact be within a physical boundary of the enterprise 101. For instance, the criterion can be that the current artifact has been developed at a given geographic location, building, etc. As an example, the criterion can be that the current artifact has been developed in the United States. In some embodiments, the criterion can be that the new and current artifacts be in a same physical boundary of the enterprise 101. In other embodiments, the criterion can be that the new and current artifacts be in different physical boundaries.

In another example, the collaboration criterion can be that the current artifact be of a given type. For instance, for the Agile development methodology, the criterion can be that the current artifact be a story, a feature, a capability, an epic, etc. In some embodiments, the criterion can be that the new and current artifacts be of a same type. In other embodiments, the criterion can be that the new and current artifacts be of a different type.

In another example, the collaboration criterion can be that the current artifact be in a particular stage of development. For instance, the criterion can be that the current artifact has completed development, still in design stage, at development stage X, prior to system testing of the product of which the current artifact is a part, etc. In some embodiments, the criterion can be that the new and current artifacts be in the same development stage or within N number of development stages of each other.

Other example collaboration criteria that is related to the Agile development methodology is further described below.

At stage E, if any of the current artifacts satisfy the collaboration criterion, a collaboration notification is transmitted to the team member(s) associated with the new artifact. In this example, the artifact manager 106 transmits a collaboration notification to the account, device, etc. of the team member in the product team 122 assigned to the new artifact.

While described such that a team member associated with a new artifact is provided collaboration notification for a current artifact in the same enterprise, in some embodiments, the team member associated with the new artifact can be provided collaboration notification of external current sources or artifacts that are external to the enterprise. For example, the external current sources or artifacts can be artifacts from a different enterprise for which there is collaboration. In another example, the external current sources or artifacts can be published papers, web sites that include relevant information, blogs, etc.

### Example Agile Development Methodology

FIG. 2 depicts an example framework for a development methodology, according to some embodiments. FIG. 2 depicts a framework 200 that represents an example Agile development methodology. The framework 200 provides an infrastructure for software development for an enterprise using various numbers of product teams. The Agile development methodology enables software to be developed incrementally with fast, integrated learning cycles using these teams. The Agile development methodology puts a priority on individual persons, interactions, and cross-functional teams. This methodology is in contrast to traditional development that places more value on processes, comprehensive documentation, and unchanging plans.

The framework 200 includes a portfolio level 281 and a program and team level 282. For some enterprises, there can be multiple portfolios. The portfolio level 281 is the highest level that provides constructs for organizing an enterprise 201 based on a flow of value via values streams 211-213, which can represent one or more values streams for the enterprise 201. The portfolio level 281 also includes strategic themes 203 provided by the enterprise 201. The strategic themes 203 can be specific, itemized business objectives for the enterprise 201 that guide the development of the products. The strategic themes 203 can dictate budgets 215, which create the value streams 211-213. For example, a strategic theme can be lower costs for warehouse for an enterprise that is an online retailer. In another example, a strategic theme can be to standardize across three different platforms for the software products for the enterprise 201.

The values streams 211-213 provide funding for the people and any other resources necessary to develop solutions that deliver value. A first type of value stream is operational. An operational value stream depicts the steps to provide goods or services to either an external or internal customer. A second type of a value stream is development, which depicts the steps to develop capabilities for products, systems, services, etc. A release train 220 at the program and team level 282 is created to realize one or more values streams. In this example, the release train 220 is create to realize the value stream 211. An output of the release train 220 is a solution 291 (e.g., a product) delivered to a customer 293.

The program and team level 282 includes the release train 220. The program and team level 282 also includes a number of product teams (shown as product teams 231-233). Each of the product teams 231-233 can include a product owner, a scrum master, and team members as described in reference to the product team 122 depicted in FIG. 1.

The program and team level 282 also includes program increments and planning 235 and 237. The release train 220 includes program increment planning 235 to plan a first program increment. The release train 220 also includes a number of subsequent stages that include completion of a program increment and planning for a next program increment (termed “program increment and planning”). In this example, the release train 220 includes program increment and planning 235 and program increment and planning 237. A program increment can be defined as a plan-do-check-adjust learning cycle. Each program increment can be considered a development timebox that uses cadence and synchronization to facilitate planning. Each program increment can include multiple teams. Also, each program increment can include multiple iterations of development. A program increment planning includes an event where members of each product team that are part of development of the solution 291 to the customer 293.

In this example, the first program increment 235 includes iterations 239, and the second program increment 237 includes iterations 241. In this example, each of the iterations 239 and iterations 241 include four different iterations. Also, during a program increment one or more releases can be made. These releases of the product (e.g., software) can be provided for release into the customer's environment. In this example, a release 271 occurs during the first program increment. A release 273 also occurs at the completion of the first program increment. A release 275 occurs during the second program increment. Also, a release 277 occurs at the completion of the second program increment.

In some embodiments, collaboration criterion between a new artifact and current artifacts can be based on one or more components of the framework 200. For example, the collaboration criterion can be based the strategic themes 203. For instance, a new artifact is provided notification of a similar current artifact if the new artifact and the current artifact on part of a same strategic theme. In another instance, a new artifact is provided notification of a similar current artifact if the new artifact and the current artifact are in different strategic themes.

The collaboration criterion can also be based the values streams 211-213. For instance, a new artifact is provided notification of a similar current artifact if the new artifact and the current artifact on part of a same value stream. In another instance, a new artifact is provided notification of a similar current artifact if the new artifact and the current artifact are in different value streams.

The collaboration criterion can also be based the product or product types. For instance, a new artifact is provided notification of a similar current artifact if the new artifact and the current artifact on part of a same product, previous version of a product, or a same product type. In another instance, a new artifact is provided notification of a similar current artifact if the new artifact and the current artifact are in different products or different product types.

The collaboration criterion can also be based the release train. For instance, a new artifact is provided notification of a similar current artifact if the new artifact and the current artifact on part of a same release train. In another instance, a new artifact is provided notification of a similar current artifact if the new artifact and the current artifact are in different release trains.

The collaboration criterion can also be based the program increments, iterations, or releases. For instance, a new artifact is provided notification of a similar current artifact if the current artifact is beyond a particular program increment in the product development. In another instance, a new artifact is provided notification of a similar current artifact if the current artifact is not beyond a particular program increment in the product development. In another example, a new artifact is provided notification of a similar current artifact if the current artifact has been a part of at least N number of releases. In another instance, a new artifact is provided notification of a similar current artifact if the current artifact has been a part of less than X number of releases. In another example, a new artifact is provided notification of a similar current artifact if the current artifact has been a part of at least Y number of iterations. In another instance, a new artifact is provided notification of a similar current artifact if the current artifact has been a part of less than Z number of iterations.

### Example Operations

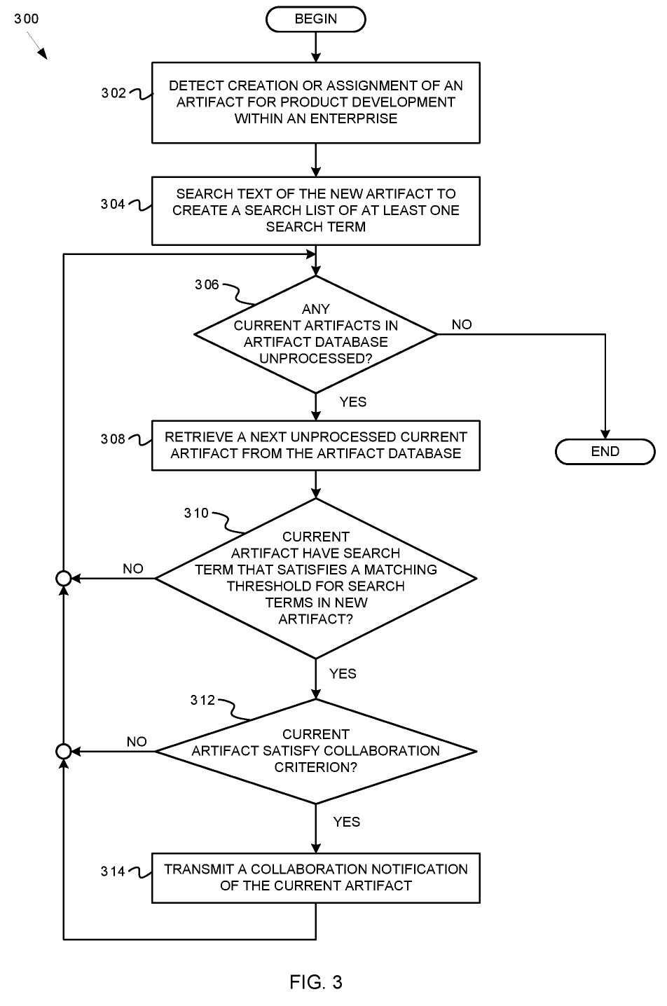

FIG. 3 depict a flowchart for collaboration notification of development based on artifact analysis, according to some embodiments. A flowchart 300 of FIG. 3 is described with reference to the system 100 of FIG. 1. Operations of the flowchart 300 can be performed by software, firmware, hardware or a combination thereof. The operations of the flowchart 300 start at block 302.

Creation or assignment of an artifact for product development in an enterprise is detected (302). With reference to FIG. 1, the artifact manager 106 can detect creation or assignment of an artifact. For example, a team member of the product team 122 can be assigned a story that provides a description of functionality that is to be developed as part of a software product being developed by the product team 122. In response to the artifact being created or assigned to a team member(s) in the enterprise 101, the device of the team member or the device of the product owner for the team can transmit a communication to the artifact manager 106 that the artifact has been assigned. Alternatively, the artifact manager 106 can create and assign the artifact based on instructions from the product owner or the team member.

Text of the new artifact is searched to create a search list of at least one search term (304). With reference to FIG. 1, the search engine 107 can process the new artifact to identify at least one search term. Alternatively or in addition, one or more persons can identify the key search terms in the new artifact. For example, the team member who has been assigned the artifact, the product owner for the team, etc. can identify the search terms.

A determination is made of whether any current artifacts in the artifact database are unprocessed (306). With reference to FIG. 1, the artifact manager 106 can make this determination. In particular, each of the current artifacts can be processed to determine whether the current artifact include similar or same the search terms as included in the search list for the new artifact. Therefore, the artifact manager 106 can determine whether any current artifacts in the artifact database 108 have not yet been processed to determine whether the current artifact include similar or same the search terms as included in the search list for the new artifact. If there are no unprocessed artifacts, operations of the flowchart 300 are complete. Otherwise, operations of the flowchart 300 continue at 308.

A next unprocessed current artifact from the artifact database is retrieved (308). With reference to FIG. 1, the artifact manager 106 can retrieve the next unprocessed current artifact from the artifact database 108. The artifact manager 106 can retrieve the unprocessed current artifacts according to different orders. For example, the artifact manager 106 can retrieve the unprocessed current artifacts in a sequential order based on date of creation in the artifact database 108. For instance, the artifact manager 106 can starting with the most newly created artifact, continue with the next most recently created artifact, etc.

A determination is made of whether the current artifact selected for processing includes search terms that satisfy a matching threshold for the new artifact (310). With reference to FIG. 1, the search engine 107 can make this determination. For example, the search engine 107 can identify the current artifact has same or similar terms as the new artifact if a matching threshold is met. For instance, if the current artifact has at least N number of same or similar terms, the search engine 107 can identify the current artifact as being a candidate for collaboration with the new artifact. The value of N can vary based on different criteria. For example, if the new artifact is a story for product X, the value of N can be lower in comparison to a new artifact for a story for product Z. In another example, if the current artifact is for a same product or a different product in a same division of the enterprise 101 as the new artifact, the value of N can be lower in comparison to a current artifact that is for a different product in a different division of the enterprise 101. In another example, if the current artifact is from a person that is more than X number of levels above or below the person assigned to the new artifact, the value of N can be greater in comparison to a current artifact that is from a person that is less than X number of levels above or below the person assigned to the new artifact. If the current artifact selected for processing does not include search terms that satisfy a matching threshold for the new artifact, operations of the flowchart 300 return to 306 where a determination is again made of whether there are any remaining unprocessed current artifacts. If the current artifact selected for processing does include search terms that satisfy a matching threshold for the new artifact, operations of the flowchart 300 continue at 312.

A determination is made of whether the current artifact satisfies a collaboration criterion (312). The artifact manager 106 can make this determination. The collaboration criterion can be based on an attribute of at least one of the new artifact or the current artifact. Collaboration criteria can also be based on the infrastructure of the enterprise and the development methodology (e.g., Agile development methodology). As described above, the collaboration criterion can be that the new artifact be within N vertical levels of the current artifact within the enterprise. In another example, the collaboration criterion can be that the current artifact be within a logical boundary of the enterprise 101. In some embodiments, the criterion can be that the new and current artifacts be in a same logical boundary or different logical boundaries of the enterprise 101. In another example, the collaboration criterion can be that the current artifact be within a physical boundary of the enterprise 101. In some embodiments, the criterion can be that the new and current artifacts be in a same physical boundary or different physical boundaries of the enterprise 101. In another example, the collaboration criterion can be that the current artifact be of a given type. In some embodiments, the criterion can be that the new and current artifacts be of a same type or different types. In another example, the collaboration criterion can be that the current artifact be in a particular stage of development. In some embodiments, the criterion can be that the new and current artifacts be in the same development stage or within N number of development stages of each other.

Other example collaboration criterion that is related to the Agile development methodology (312). If the current artifact does not satisfy the collaboration criterion, operations of the flowchart 300 return to 306 where a determination is again made of whether there are any remaining unprocessed current artifacts. If the current artifact does satisfy the collaboration criterion, operations of the flowchart 300 continue at 314.

A collaboration notification of the current artifact is transmitted (314). With reference to FIG. 1, the artifact manager 106 can transmit the collaboration notification of the current artifact to the team member(s) assigned to the new artifact. For example, the artifact manager 106 can transmit the collaboration notification to an account, a device, etc. of the team member(s). Operations of the flowchart 300 return to 306 where a determination is again made of whether there are any remaining unprocessed current artifacts.

### Example Computer Device

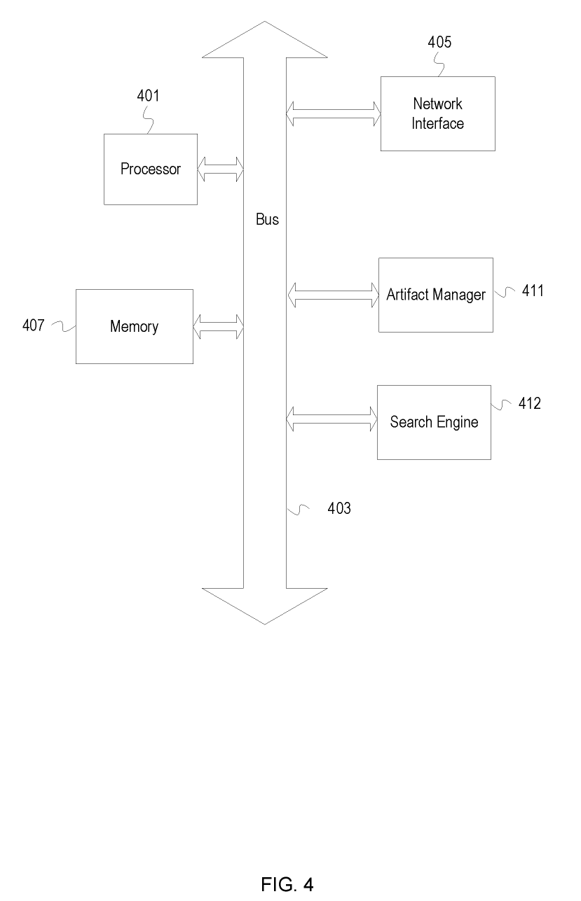

FIG. 4 depicts an example computer device, according to some embodiments. The computer device includes a processor 401 (possibly including multiple processors, multiple cores, multiple nodes, and/or implementing multi-threading, etc.). The computer device includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The computer device also includes a persistent data storage 409. The persistent data storage 409 can be a hard disk drive, such as magnetic storage device. The computer device also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.).

The computer device also includes an artifact manager 411 and a search engine 412. The artifact manager 411 can perform operations to determine collaboration among artifacts and possible notification of such collaboration, as described above. The search engine 412 can search artifacts to locate search terms. The search engine 412 can also determine whether a current artifact can be eligible for collaboration notification for a new artifact based on a matching threshold, as described above. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401, the network interface 405, and the persistent data storage 409 are coupled to the bus 403. Although illustrated as being coupled to the bus 403, the memory 407 may be coupled to the processor 401.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing. Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

While the aspects of the disclosure are described with reference to various implementations and exploitations, it will be understood that these aspects are illustrative and that the scope of the claims is not limited to them. In general, techniques for performing metric contextualization in distributed computing environments as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
creating or assigning a first artifact document that includes a description of a component of a product that is included in a product development cycle, and wherein the description is associated with a product development entity and includes a description of functionality of the product;
in response to said creating or assigning the first artifact document, utilizing a text-based search engine to identify search terms in the first artifact document; and
for each of a plurality of artifact documents currently stored by a development enterprise,
determining whether the stored artifact document includes text that matches the identified search terms in the first artifact document to a degree that satisfies a matching threshold; and
in response to determining satisfaction of the matching threshold,
determining whether the first artifact document satisfies a collaboration criterion that is based, at least in part, on an attribute of the first artifact document and the stored artifact document; and
in response to determining that the collaboration criterion is satisfied, transmitting to the product development entity a collaboration notification regarding the stored artifact document.

2. The method of claim 1, wherein transmitting the collaboration notification comprises transmitting the collaboration notification to at least one of a device of a member and a device of a team in the enterprise assigned the first artifact.

3. The method of claim 1, wherein the collaboration criterion comprises that a member assigned to the first artifact be within N vertical levels of the enterprise of a member assigned to the stored artifact.

4. The method of claim 1, wherein the collaboration criterion comprises that a member assigned to the stored artifact be within a logical boundary of the enterprise.

5. The method of claim 1, wherein the collaboration criterion comprises that development performed as defined by the stored artifact document be within a physical boundary of the enterprise.

6. The method of claim 5, wherein the collaboration criterion comprises that development to be performed as defined in the first artifact document be within a same physical boundary as development performed as defined in the stored artifact document.

7. The method of claim 1, wherein the first artifact document comprises a new story defining a requirement of the product being developed in the development enterprise, wherein the new story is part of a first epic, wherein the collaboration criterion comprises that the stored artifact document be in the first epic.

8. The method of claim 1, wherein the first artifact document is created to satisfy a first enterprise objective among a limited set of enterprise objectives, wherein the collaboration criterion comprises that the stored artifact document be in a same enterprise objective within the limited set of enterprise objectives.

9. The method of claim 1, wherein the attribute of the stored artifact document comprises a stage of development of the product.

10. The method of claim 1, wherein at least one other stored artifact document is marked as private, wherein the at least one other stored artifact document marked as private is excluded from the determining.

11. An apparatus comprising:
a processor; and
a machine-readable medium having program code executable by the processor to cause the apparatus to:
create or assign a first artifact document that includes a description of a component of a product that is included in a product development cycle, and wherein the description is associated with a product development entity and includes a description of functionality of the product;
in response to said creating or assigning the first artifact document, utilize a text-based search engine to identify search terms in the first artifact document; and
for each of a plurality of artifact documents currently stored by a development enterprise,
determine whether the stored artifact document includes text that matches the identified search terms in the first artifact document to a degree that satisfies a matching threshold; and
in response to a determination satisfaction of the matching threshold,
determine whether the first artifact document satisfies a collaboration criterion that is based, at least in part, on an attribute of the first artifact document and the stored artifact document; and
in response to a determination the first artifact satisfies the collaboration criterion, transmitting to the product development entity a collaboration notification regarding the stored artifact document.

12. The apparatus of claim 11, wherein the program code executable by the processor to cause the apparatus to transmit the collaboration notification comprises program code executable by the processor to cause the apparatus to transmit the collaboration notification to at least one of a device of a member and a device of a team in the enterprise assigned the first artifact.

13. The apparatus of claim 11, wherein the collaboration criterion comprises that a member assigned to the first artifact be within N vertical levels of the enterprise of a member assigned to the stored artifact.

14. The apparatus of claim 11, wherein the collaboration criterion comprises that a member assigned to the stored artifact be within a logical boundary of the enterprise.

15. The apparatus of claim 11, wherein the collaboration criterion comprises that development performed as defined in the stored artifact document be within a physical boundary of the enterprise.

16. The apparatus of claim 15, wherein the collaboration criterion comprises that development to be performed as defined in the first artifact document be within a same physical boundary as development performed as defined in the stored artifact document.

17. The apparatus of claim 11, wherein the first artifact document comprises a new story defining a requirement of the product being developed in the development enterprise, wherein the new story is part of a first epic, wherein the collaboration criterion comprises that the stored artifact document be in the first epic.

18. The apparatus of claim 11, wherein the attribute of the stored artifact document comprises a stage of development of the product.

19. One or more non-transitory machine-readable media comprising program code for collaboration in an enterprise, the program code to:
create or assign a first artifact document that includes a description of a component of a product that is included in a product development cycle, and wherein the description is associated with a product development entity and includes a description of functionality of the product;
in response to said creating or assigning the first artifact document, utilize a text-based search engine to identify search terms in the first artifact document;
and
for each of a plurality of artifact documents currently stored by a development enterprise,
determine whether the stored artifact document includes text that matches the identified search terms in the first artifact document to a degree that satisfies a matching threshold; and
in response to determining satisfaction of the matching threshold,
determine whether first artifact document satisfies a collaboration criterion comprising that the product development entity assigned to the first artifact be within N vertical levels of a product development entity within the development enterprise that is assigned the stored artifact document; and
in response to a that the collaboration criterion is satisfied, transmit to the product development entity a collaboration notification of the stored artifact document.

20. The one or more non-transitory machine-readable media of claim 19, wherein the first artifact document is created to satisfy a first enterprise objective among a limited set of enterprise objectives, wherein the collaboration criterion comprises that the stored artifact document be in a same enterprise objective within the limited set of enterprise objectives.
